(19) United States
(12) Patent Application Publication
(10) Pub. No.: US 2018/0226834 A1
(43) Pub. Date: Aug. 9, 2018

(54) An Inductive Power Receiver

(71) Applicant: PowerbyProxi Limited, Auckland (NZ)

(72) Inventor: Liang Chen, Auckland (NZ)

(21) Appl. No.: 15/739,076

(22) PCT Filed: Jun. 28, 2016
(86) PCT No.: PCT/NZ2016/050103

§ 371 Date: Dec. 21, 2017

Related U.S. Application Data
(60) Provisional application No. 62/185,837, filed on Jun. 29, 2015.

(51) Int. Cl. H02J 50/12; H02J 7/02; H02M 7/219

(52) U.S. Cl. CPC H02J 50/12; H04M 1/0202; H02M 7/219; H02J 7/025

(57) ABSTRACT

An inductive power receiver for an inductive power transfer system including a power regulation circuit configured to adjust a DC bias voltage across a capacitor to regulate the DC output voltage. The capacitor may 5 be provided within a switched bridge rectifier and the switching sequence of the switched bridge rectifier may be controlled to charge or discharge the capacitor to provide power flow control.

### FIELD

This invention relates generally to an inductive power receiver.

### BACKGROUND

Inductive power transfer (IPT) technology is an area of increasing development and IPT systems are now utilised in a range of applications and with various configurations. Typically, a primary side (i.e., an inductive power transmitter) will include a transmitting coil or coils configured to generate an alternating magnetic field. This magnetic field induces an alternating current in the receiving coil or coils of a secondary side (i.e., an inductive power receiver). This induced current in the receiver can then be provided to some load, for example, for charging a battery or powering a portable device. In some instances, the transmitting coil(s) or the receiving coil(s) may be suitably connected with capacitors to create a resonant circuit. This can increase power throughput and efficiency at the corresponding resonant frequency.

A problem associated with IPT systems is regulating the amount of power provided to the load. It is important to regulate the power provided to the load to ensure the power is sufficient to meet the load's power demands.

Similarly, it is important that the power provided to the load is not excessive, which may lead to inefficiencies. Generally, there are two approaches to power control in IPT systems: transmitter-side power control and receiver-side power control.

In transmitter-side power control, the transmitter is typically controlled to adjust the power of the generated magnetic field (for example, by adjusting the power supplied to the transmitting coil(s)).

In receiver-side power control, the receiver is controlled to adjust the power provided to the load from the receiving coils (for example, by including a regulating stage or by adjusting the tuning of the receiver).

A problem associated with some receiver-side power control systems that rely on regulating stages is that such regulating stages will often need to include components, such as DC inductors acting as an energy store so that power can be suitably regulated which can be relatively large in terms of volume, which cannot be readily miniaturized so that the receiver may fit within portable electronic devices.

Another common problem with receivers used in IPT systems is that variations in the operating frequency of the transmitter or resonant frequency of the receiver (due to, for example, changes in load or other circuit parameters), can affect the amount and efficiency of power transfer.

Accordingly, the present invention may provide an improved IPT receiver or may at least provide the public with a useful choice.

### SUMMARY

According to one exemplary embodiment there is provided an inductive power receiver for an inductive power transfer system comprising:
a power receiving coil;
a rectifier configured to convert a voltage from the power receiving coil into a substantially DC voltage for a load; and
a power regulation circuit configured to adjust a DC bias voltage across at least one capacitor to regulate the DC voltage.

According to another exemplary embodiment there is provided a method of controlling an inductive power receiver comprising:
generating a DC bias voltage across at least one capacitor in the receiver; and
regulating the load based on the DC bias voltage.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that the document is prior art, that it is validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a schematic diagram of an inductive power transfer system according to one embodiment;

FIG. 2 is a simplified diagram of an inductive power receiver;

FIG. 3 is a schematic of a circuit for power regulation in an inductive power receiver according to an embodiment;

FIGS. 4a-4d are graphs of waveforms for power regulation in the circuit of FIG. 3;

FIG. 5 is a schematic of a circuit for power regulation in an inductive power receiver according to another embodiment;

FIG. 6 is a schematic of a circuit for power regulation in an inductive power receiver according to another embodiment;

FIG. 7 are graphs of waveforms for power regulation in the circuit of FIG. 6;

FIG. 8 is a schematic of a circuit for power regulation in an inductive power receiver according to another embodiment; and

FIG. 9 are graphs of waveforms for power regulation in the circuit of FIG. 8.

### DETAILED DESCRIPTION

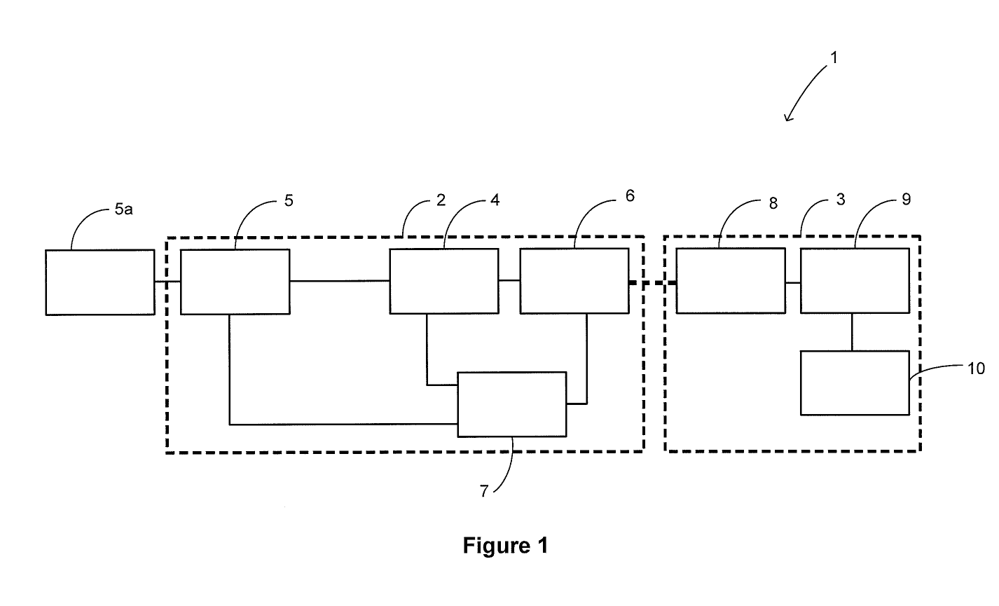

FIG. 1 shows a representation of an inductive power transfer (IPT) system 1 according to an example embodiment. This representation is intended to be general representation so as to introduce different parts of the IPT system that will be described in more specific detail in relation to later figures. This may be suitably modified or supplemented for particular embodiments according to the application. The IPT system includes an inductive power transmitter 2 and an inductive power receiver 3.

The transmitter 2 includes a converter 4 that is connected to an appropriate power supply. In FIG. 1 the power supply is shown as a DC-DC converter 5 that is connected to a DC power supply 5a, however other arrangements are possible. The converter may be a non-resonant half bridge converter or any other converter adapted for the particular IPT system, such as a push-pull converter. The converter is configured to output an alternating current of desired frequency and amplitude. The voltage of the output of the converter may also be regulated by the converter, the DC-DC converter or combination of both.

The converter 4 is connected to transmitting coil(s) 6. The converter supplies the transmitting coil(s) with an alternating current such that the transmitting coil(s) generates a time-varying magnetic field with a suitable frequency and amplitude. In some configurations, the transmitting coil(s) may also be considered to be an integral part of the converter, but for the sake of clarity this description will refer to them as distinct.

The transmitting coil(s) 6 may be any suitable configuration of coils, depending on the characteristics of the magnetic field that are required in a particular application and the particular geometry of the transmitter. In some IPT systems, the transmitting coils may be connected to capacitors (not shown) to create a resonant circuit. Where there are multiple transmitting coils, these may be selectively energised so that only transmitting coils in proximity to suitable receiving coils are energised. In some IPT systems, it may be possible that more than one receiver may be powered simultaneously. In IPT systems, where the receivers are adapted to control the power provided to the load (as, for example, in the embodiments in more detail below), the multiple transmitting coils may be connected to the same converter. This has the benefit of simplifying the transmitter as it does not need to control each transmitting coil separately. Further, it may be possible to configure the transmitter so that it regulates the power provided to the transmitting coils to a level dependent on the coupled receiver with the highest power demands.

FIG. 1 also shows a controller 7 within the transmitter 2. The controller can be connected to each part of the transmitter. The controller is adapted to receive inputs from each part of the transmitter and produce outputs that 1 o control the way each part of the transmitter operates. The controller may include a memory. The controller may be a programmable logic controller that is programmed to perform different computational tasks depending on the requirements of the IPT system.

The receiver 3 includes power receiving circuitry 8, which includes one or more receiver coils, suitably connected to power conditioning circuitry 9 that in turn supplies power to a load 10. The power conditioning circuit is configured to convert current induced in the receiver coils into a form that is appropriate for the load. As will be appreciated, the power receiver 3 receives inductive power from the power transmitter 2 and provides the power to the load.

The load may be any suitable load depending upon the application for which the inductive power receiver is being used. For example, the load may be a portable electronic device or a battery that requires charging.

The power demands of a load often vary significantly, therefore it is important that the power provided to the load matches what is required for normal and safe operation. In particular, the power supplied to a load must be sufficient to meet the power demands whilst not being too excessive which may lead to undesired inefficiencies such as heating.

Accordingly, power conditioning circuitry is incorporated into the receiver 3 to meet the electrical requirements of the load. Power conditioning circuitry typically comprises rectifiers, regulators, smoothing circuits and control circuits.

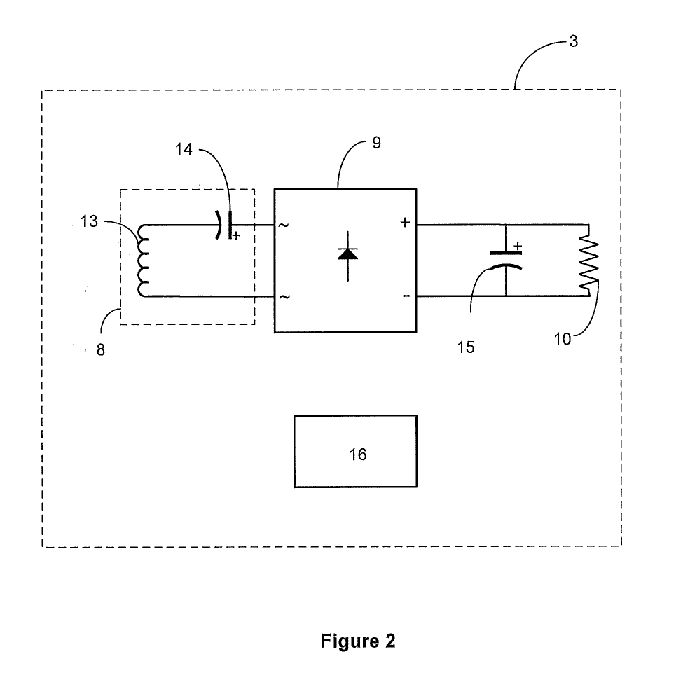

FIG. 2 illustrates an example of the fundamental circuit topology of an inductive power receiver. The circuit comprises power receiving circuitry 8 including a receiving coil 13 shown as an inductor and a capacitor 14.

The output of power receiving circuitry 8 is provided to a rectification circuit 9 that operates to convert received oscillating voltages into DC voltages suitable for providing power to a load. The rectification circuit may be a full bridge or half bridge circuit. Embodiments of the rectifier may be constructed with asymmetric current flow devices, diodes, or controlled switches or a combination of any suitable asymmetric current flow devices such as diodes and controlled switches.

Controlled switches may provide improved performance over diodes but they must be controlled so that they are switched on and off to control the flow of current. Possible controlled switches include any transistors such as MOSFETs, IGBTs or BJTs.

A load 10 and a DC smoothing capacitor 15 are shown connected to the output of the rectification circuit 9.

The term “coil” as used in this specification may include an electrically conductive structure where an electrical current generates a magnetic field, or a magnetic field generates a current. For example, inductive “coils” may be electrically conductive wire in three dimensional shapes or two dimensional planar shapes, electrically conductive material fabricated using printed circuit board (PCB) techniques into three dimensional shapes over plural PCB ‘layers’, and other coil-like shapes. The coil may have having two or more connections. For example, three coil connections could be provided using a centre tapped coil for allowing several voltages levels to be tapped. The use of the term “coil” in either singular or plural is not meant to be restrictive in this sense. Other configurations may be used depending on the application.

The coil 13 and capacitor 14 together form a circuit receptive to the inductive power transmission field. In some configurations, the coil 13 and capacitor 14 are tuned to resonate at or close to frequency of field oscillation of the inductive power transmitter. However, in other configurations the resonant circuit is tuned for reception to a wide range of inductive power transmission field frequencies.

In some embodiments, it may be desirable to have one or more additional coils and/or capacitors to form additional resonant circuits. For simplicity, the power receiver 3 of FIG. 2 is shown with one receiver resonant circuit 12. However, there may be multiple receiver resonant circuits configured to operating independently or in parallel. For example, in some portable devices there may be receiving coils located on different parts of the portable device. The resonant circuits may all be connected to power regulation and conditioning circuitry, or they may each be connected with associated receiver circuitry such as inverters either driven in-phase or out-of-phase to provide a multiphase system. In some embodiments, the circuit is configured to enable the selective use of each resonant circuit.

The receiving coil 13 and resonant capacitor 14 are connected in series and known as resonant circuit that is ‘series-resonant’. The coils of the resonant circuit receive power from a time-varying magnetic field generated by the transmitter 2 to produce an AC output. The values of the receiving coil and resonance capacitor may affect the resonant frequency of the receiver, and that the receiving coil and resonance capacitor may be selected so as to resonate at the operating frequency of the transmitter or any other suitable frequency. In some embodiments the receiver is tuned outside of the transmitter frequency to enable active tuning in the receiver to bring the IPT system into tune. Other considerations may also influence the type and size of the receiving coil and resonant capacitor used in the receiver, for example, the dimensions of the receiver or device in which the receiver is used, or the required power.

Embodiments also comprise a power regulation circuit that may be constructed as part of the power receiving circuitry 8 the rectification circuitry 9, or a combination thereof. Embodiments comprising a regulation circuit are discussed in detail below.

The receiver 3 further comprises a controller 16. The controller 16 may be connected to some or all parts of the inductive power receiver 3. The controller 3 may be configured to receive inputs from parts of the inductive power receiver and produce outputs that control the operation of each part. The controller 3 may be implemented as a single unit or multiple harmonious units in communication with one another. For example, the receiver controller may be one or more of a microprocessor, programmable logic controller or similar controller that is programmed to perform different computational tasks depending on the requirements of the receiver 3.

The controller 16 may be configured to control specific aspects of the receiver 3 such as power regulation, coil tuning and/or communication with other computational devices in the receiver or even in the power transmitter. The controller 16 may be further configured to selectively enable one or more receiver resonant circuits in a system with multiple resonant circuits.

It is desirable for an IPT receiver to have the ability to regulate power supplied to the load to thereby facilitate the receiver to, for example, pick-up power from an uncontrolled magnetic field or to allow two or more receivers to independently receive power from the same magnetic field. However, it is important that the regulator be efficient in order to minimise heat production and current flow ability. Further, it is advantageous that the regulator have a minimum possible part count in order to reduce the require circuit board real estate and manufacturing cost.

One effective and simple implementation of a regulator is a synchronous rectifier combined with a switch mode DC-DC converter. However a disadvantage of DC-DC converters is an additional high current inductor is required for high loading and the introduction of additional switching losses associated with the buck conversion. It may be desirable to reduce the pick-up losses in an IPT receiver while still producing as much or as little power as is required by the secondary side load.

One or more embodiments may mitigate the requirement for an additional regulator after the rectifier, and also therefore also mitigate the requirement for any further external inductors. Power loss in the IPT receiver may be reduced and the manufacturing cost of the receiver may also be reduced.

In a conventional rectifier or synchronous rectifier in an IPT receiver, the average output power is directly related to the average pick-up coil current.

In one or more embodiment, a circuit is configured to generate a DC bias voltage across one or more capacitors to adjust the current flow to the load. A DC bias voltage in a capacitor acts to regulate the flow of current through that capacitor. This may allow control of the output power to be independent of the current in the pick-up coil. This adjustment may be useful in providing effective power flow control under extreme loading and/or coupling conditions and may avoid the losses normally associated with those scenarios.

The biased capacitor may be a capacitor configured in series with the power receiving coil as part of the power receiving circuit. Alternatively the capacitor may be configured as part of a full bridge rectifier circuit. There may be a capacitor in series with the power receiving coil and a capacitor as part of a full bridge rectifier circuit.

The controller may then operate switching devices to generate the DC bias voltage across the one or more capacitors in the circuit. For example, the controller may switch of one or more switching devices to regulate the current in or out of the capacitor so as to regulate the current through the load. Advantageously, regulation may be performed simply by the switch timing of one or two switching devices allowing part count and processor pin use to be minimised.

### Example 1

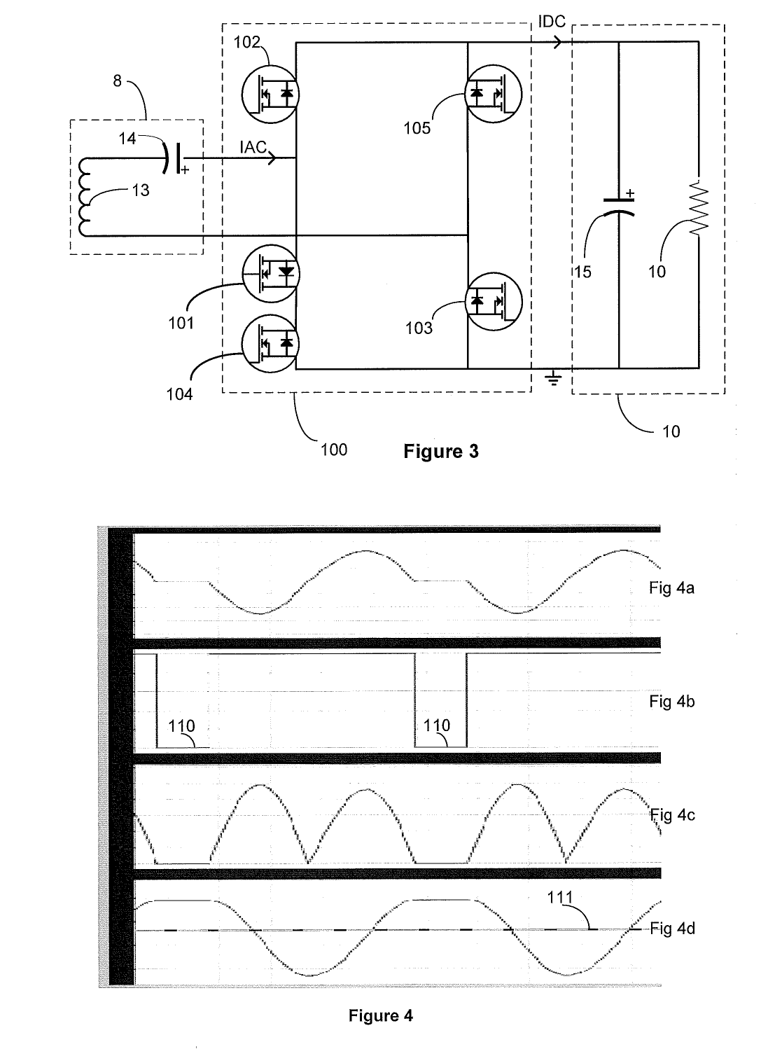

Referring to FIG. 3, a receiver circuit is shown having the elements of a power receiving circuitry 8, a rectification circuit 100 and a load circuit 10. The power receiving circuit 8 comprises a series tuned power receiving coil 13 and capacitor 14. The rectification circuit 100 is configured to convert the oscillating AC voltage from the power resonant circuit into a DC voltage for use by load 10. A parallel DC capacitor 15 is provided for smoothing.

The rectification circuit 100 comprises a full bridge arrangement of switching devices configured to conduct in synchrony with the phase of the incoming AC voltage and thereby create a desired transformation to DC voltage. Each switching device must be controlled so that they are switched on and off to control the flow of current. A controller controls the conduction timing and phase of each switching device in harmony with the oscillating frequency of the incoming AC waveform. Switches may include transistors such as MOSFETs, IGBTs or BJTs. MOSFETs together with their body diodes are depicted in the following examples.

Switches 102 and 103 conduct during one half cycle of an incoming oscillating voltage, and switches 104 and 105 conduct on the other half cycle. In combination a full bridge rectifier is formed.

The conduction timing of each switch is controlled by the controller 16. For example, the controller may apply a voltage to the gate of a MOSFET switching device to enable conduction. The controller is configured to receive inputs from parts of the receiver which can include the current and voltage being supplied to the load 10. The controller may also be provided with the load's power requirements by inputs or any other suitable means.

The rectification circuit 100 includes an additional switching device 101 configured in one leg of the bridge. The additional switching device 101 together with the series capacitor 14 in the power receiving circuit 8 form a power regulation circuit operable to control the flow of current to the load 10.

The controller 16 is further configured to control the conduction of the additional switching device 101 to effectively generate a DC voltage bias across the capacitor 14 by virtue of a nonzero average voltage being created across the capacitor for one full phase of the incoming AC voltage from the receiver coil. Charge build up in a capacitor affects the conductivity and therefore the power that can be drawn through it. The capacitor 14 is configured to regulate power from the power receiving circuit to the load 10 by control of the DC bias across it.

During full power operation of the circuit, switching device 101 is controlled to conduct for the entire cycle of the incoming voltage waveform. The switching devices 102-105 in the bridge operate to provide for normal rectification. To regulate current to the load, the controller 16 is configured to adjust the conduction timing of switch 101 such that the switch is off for a period of every incoming AC oscillation cycle while the remaining switching devices in the rectifier bridge operate normally. Any nonconductive period of the switching device 101 builds a charge in the capacitor 14 that in turn regulates current flow to the load.

Regulation can therefore be provided by control of a single additional switch to a full bridge synchronous rectifier thereby allowing easy control with minimal switching losses. The additional switch offers further advantages of negligible switching losses and minimal conduction losses.

FIGS. 4a to 4d show graphs of time varying voltage waveforms operable for rectification and current regulation in the circuit embodiment shown in FIG. 3. In particular, FIG. 4a shows the current IAC flowing from the capacitor 14 in the power receiving circuit 8. FIG. 4b shows a control voltage waveform and therefore the conduction timing of regulation control switch 101. FIG. 4c shows the current IDC flowing to the smoothing capacitor 15. FIG. 4d shows a waveform of the voltage across the capacitor 14 in the power receiving circuit 8.

As can be seen, the off period 110 of the switch 101 produces zero IAC current flowing through capacitor 14. Voltage across the smoothing capacitor 15 is held substantially constant during the off phase 110 and therefore the current through capacitor 14 is raised to provide an average nonzero DC bias voltage 111. The DC bias across the capacitor 14 advantageously regulates the current flowing to the load by simple control of the conduction timing of a single switch.

### Example 2

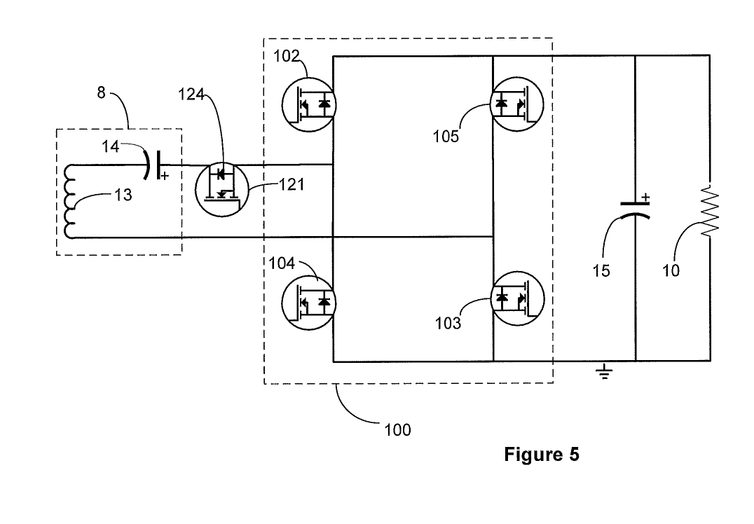

FIG. 5 shows a further embodiment of a circuit 120 to enable power regulation to a load. The circuit 120 comprises a power receiving circuit 8 having a power receiving coil 14 and a capacitor 13. The output of the power receiving circuit is provided to the input of a switching device 121 then to a rectification circuit 100 comprising an arrangement of switching devices 102 to 105 in a bridge configuration.

Circuit 120 is similar to the circuit shown in FIG. 3 in that the conduction period of the switching device 121 located between the power receiving circuit and the rectification circuit causes a DC bias build-up in the capacitor in the power receiving circuit 8 that enables regulation of the current flowing to a load. Conduction of the switching device is controlled by the controller 16. In this circuit, the switch 121 is configured in series to the capacitor to allow current flow when in a conductive state.

The body diode 124 shown in parallel with switching device 121 ensures that current flow through the capacitor is only able to be blocked in one direction or one half of the incoming voltage signal phase. When current is flowing out of the capacitor, the switching device 121 should be conductive so that diode conduction losses are minimised.

Circuit 120 provides an advantage in that a single additional switching device is required to enable power regulation control. Conduction of the switching device 121 during start up can be provided by the high side of a half bridge using bootstrapping. However, a minimal OFF time is needed to recharge the bootstrap capacitor.

### Example 3

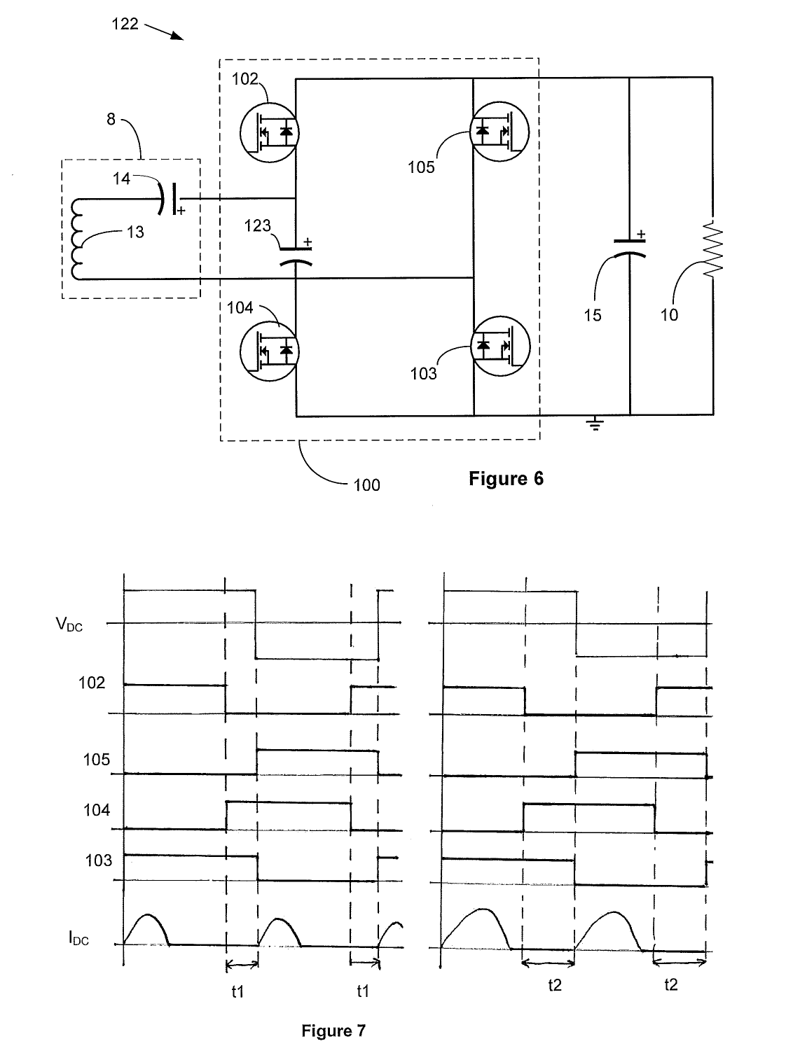

FIG. 6 shows a further embodiment a circuit 122 configured to enable power regulation to a load. The circuit 122 comprises a power receiving circuit 8 having a power receiving coil and a series configured capacitor. The power receiving circuit 8 is connected to a rectification circuit 100 that comprises an additional capacitor 123 configured in one side of a half bridge of the full bridge rectification circuit. The capacitor 123 is configured at the input of the half bridge that comprises switching devices 104 and 105.

This embodiment has advantages including that no switching devices are required in addition to those used in the rectification circuit 100. Further, only an additional capacitor is required for regulation of load currents.

In use, the conduction timing of the switching devices in the rectifier 100 are used to control the effective DC voltage bias of both the capacitor 13 in the power receiving circuit 8 and the rectifier capacitor 123. The switch timing is therefore operable to control the average current through the load.

FIG. 7 shows example graphs of time varying voltage waveforms operable for current regulation in the circuit embodiment shown in FIG. 6. In particular, the conduction phases of one side of each half of the full bridge arrangement is overlapped for a time period corresponding to the DC bias offset desired. The graphs on the left show a low load scenario and the graphs on the right show a high load scenario. Normally switches 102 and 104 would switch together and switches 105 and 103 would switch together.

By providing an overlap period where both switches 102 and 105 are on simultaneously and/or switches 104 and 103 are on simultaneously, a DC bias can be provided on capacitors 13 and 123. A shorter overlapping conduction time period t1 provides a low output current IDC. A longer overlapping conduction time period t2 provides a higher output current IDC.

When t1 is zero, at steady state the bias voltages on the capacitors are maximised and the output power is zero irrespective of the load voltage. As t1 increases, the bias voltages on the capacitors reduce and output power increases.

The controller 16 is configured to control the conduction timing of each switching device in the rectifier. The bias voltage across capacitor 123 builds when switching devices 104 and 105 are conducting during one half phase of the rectification process. However, the bias voltage will only grow until the capacitor charge meets the voltage magnitude of the voltage received by the coil.

The rectifier capacitor 123 is configured in the circuit 122 to provide control over one half of the bridge conduction. Therefore control of the switch timing allows fine control of the load currents compared to circuit configurations where control has effect on both sides of the bridge.

### Example 4

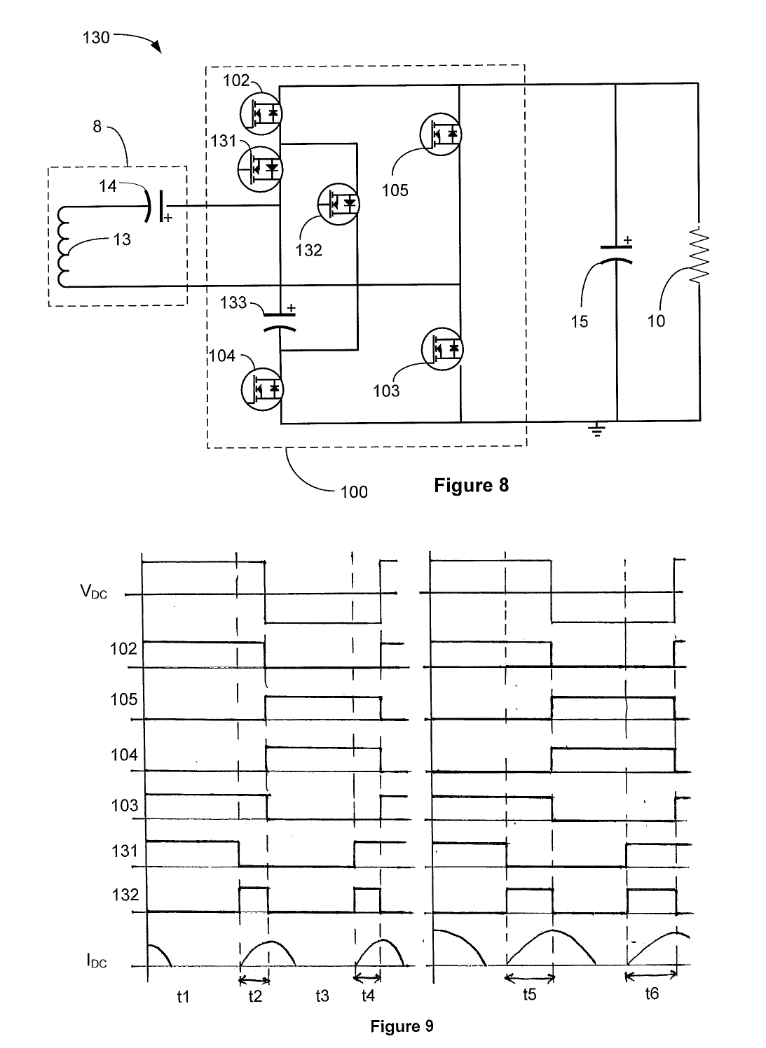

FIG. 8 shows a further embodiment where a circuit 130 is configured to enable power regulation to a load. Circuit 130 is a variation of circuit 122 shown in FIG. 6 comprising two additional switching devices configured to provide a path for a capacitor configured in a half bridge section to discharge during opposite phase operation of the rectifier 100. For example, the capacitor is able to build a charge during a positive part of the incoming

AC voltage from the power receiving circuit, then in the negative part the switches are configured to provide a discharge path. In particular, the switches 131 and 132 are configured to provide a discharge of the capacitor 133 during negative received input voltages. Additional switching elements 131 and 132 are configured in the rectifier to provide the discharge path. As the additional switches 131,132 are configured in series with some of the rectifier switches, they are controlled to allow the rectifier to operate normally when a capacitor discharge path is not required. The controller 16 is configured to control the conduction timing of each of the rectifier switches 102-105 and the additional switching elements 131, 132 that form the discharge path.

Operation of the circuit is such that regardless of the current path, power always flows through the load. In this way, the power transfer ability is not limited.

In some variations of the circuit configuration shown, the switching devices are passive devices such as diodes and require no active control over their conduction phase timing. Power regulation is controlled only by the switching states of here is the switching states of devices 131 and 132. However, the use of diodes may decrease circuit efficiency due to higher conduction losses.

In this circuit the passive component values are as follows:

### Inductor 14—13.5 uH

### Capacitor 13—0.188 uF

### Capacitor 133—10 uF

### Capacitor 15—100 uF

FIG. 9 shows graphs of switching voltage waveforms of each of the switching devices and the resulting flow of current that occurs in the circuit.

At a time period t3, switching elements 131 and 132 are switched off. Rectifier switching elements 104 and 105 are switched on to provide a rectification path for negative going received coil voltages. A voltage bias in the capacitor 133 builds up during this phase.

At time period t4, switching elements 131 and 132 are switched on and current flows from the resonant tank through switching device 105, the load, switching device 104 and then through switching elements 132 and 131 before returning to the resonant tank. This current bypasses capacitor 133 and therefore during time period t4 the capacitor 133 voltage stays the same. The length of the time period t4 controls the amount of current provided to the load. The controller 16 is configured to control time period t4 according to the current desired to be provided to the load.

Time period t1 coincides with a zero crossing of the received input voltage waveform to a positive going voltage. Switching element 131 is switched on and switching element 132 is switched off. Rectifier switching elements 102 and 103 are switched on to rectify the input voltage. The voltage across the capacitor 133 during this phase does not change as it is effectively disconnected from the presently active configuration of the circuit.

At time period t2, switching element 132 is switched on and switching element 131 is switched off. Further, rectifier switching elements 102 and 103 remain switched on. The voltage bias on the capacitor 133 reduces during this phase and current is allowed to flow to the load. The length of the time period t2 further determines the amount of current provided to the load. Therefore, the controller 16 is further configured to control time period t2 according to the current desired to be provided to the load.

The waveform graphs to the right illustrate longer time periods t5 and t6 which in turn provide less regulation and higher current flow relative to the equivalent shorter time periods t2 and t4 shown in waveform graphs on the left.

Many conventional regulation approaches will generate an intermediate voltage (that is free to vary independently of the output voltage) which is then directly regulated (with something like a switch mode converter or a simple LDO), to then generate a controlled output voltage.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver for an inductive power transfer system comprising:
a power receiving coil;
a rectifier configured to convert a voltage from the power receiving coil into a substantially DC voltage for a load; and
a power regulation circuit configured to adjust a DC bias voltage across at least one capacitor to regulate the DC voltage.

2. A receiver as claimed in claim 1, wherein the rectifier is a bridge circuit configuration and the at least one capacitor is connected within the bridge rectifier.

3. A receiver as claimed in claim 2, wherein the rectifier is a synchronous bridge rectifier.

4. A receiver as claimed in claim 1, wherein the power regulation circuit comprises one or more switching devices configured to control the flow of current through the at least one capacitor.

5. A receiver as claimed in claim 1, wherein the DC bias voltage is determined based on a load regulation criteria.

6. A receiver as claimed in claim 5, wherein the load regulation criteria is based on a voltage and/or current from the power receiving coil.

7. A receiver as claimed in claim 1, wherein the bridge rectifier is formed of switching devices and the controller is configured to dynamically control the conduction timing of switching devices to operate as a bridge rectifier.

8. A receiver as claimed in claim 7, wherein the controller is configured to dynamically control the conduction timing of switching devices in the rectifier substantially in synchronism with the received AC power signal.

9. A receiver as claimed in claim 1, wherein the power regulation circuit comprises a first switching device and a second switching device, during a first half cycle the power regulation circuit is configured to:
charge the capacitor when the first switching device is nonconductive and the second switching device is nonconductive,
maintain a bias voltage in the capacitor when the first switching device is conductive and the second switching device is conductive, and
during a second half cycle:
maintain capacitor voltage when the first switching device is conductive and the second switching device is nonconductive, and
discharge the capacitor when the first switching device is nonconductive and the second switching device is conductive.

10. A receiver as claimed in claim 1, wherein one or more of the switching devices is an MOSFET device, and the controller adjusts a voltage applied to a gate of each MOSFET device to control the conduction thereof.

11. A receiver as claimed in claim 1, wherein the receiver is configured for integration into a cellular phone for charging from a charging mat using inductive power transfer.

12. A method of controlling an inductive power receiver comprising:
generating a DC bias voltage across at least one capacitor in the receiver; and
regulating the load based on the DC bias voltage.
